(19) United States
(12) Patent Application Publication
(10) Pub. No.: US 2022/0327569 A1
(43) Pub. Date: Oct. 13, 2022

(54) LOCALLY SELECTED PLATFORM METHODS, APPARATUSES AND MEDIA

(71) Applicant: MoRewards, Inc., (US)

(72) Inventor: Conal Breslin, Bridgeport, CT (US)

(21) Appl. No.: 17/728,223

(22) Filed: Apr. 25, 2022

Related U.S. Application Data
(63) Continuation of application No. 15/216,962, filed on Jul. 22, 2016.
Application No. 15/216,962 is a continuation of application No. PCT/US2015/012961, filed on Jan. 26, 2015.
(60) Provisional application No. 61/931,138, filed on Jan. 24, 2014.

(51) Int. Cl. G06Q 30/02; G06Q 30/06

(52) U.S. Cl. CPC G06Q 30/0214; G06Q 30/02; G06Q 30/0631

(57) ABSTRACT

A description of a job may be received from a consumer. A referrer qualified to recommend providers to complete the job may be determined and a recommendation of a provider to complete the job may be obtained from the referrer. A confirmation that the recommended provider completed the job may be received and vouchers may be awarded to the consumer and to the referrer.

### CROSS-REFERENCE TO RELATED APPLICATIONS

This patent application is a continuation of and claims the benefit of priority to U.S. patent application Ser. No. 15/216,962, filed Jul. 22, 2016, which is a continuation of and claims the benefit of priority to International Application No. PCT/US2015/012961, filed Jan. 26, 2015, which claims the benefit of priority to U.S. Provisional Patent Application Ser. No. 61/931,138, filed Jan. 24, 2014. The content of each of the aforementioned patent applications are incorporated herein in its entirety by reference for any purpose whatsoever.

This disclosure describes LOCALLY SELECTED PLATFORM METHODS, APPARATUSES AND MEDIA (hereinafter “LSP”). A portion of the disclosure of this patent document contains material which is subject to copyright and/or mask work protection. The copyright and/or mask work owners have no objection to the facsimile reproduction by anyone of the patent document or the patent disclosure, as it appears in the Patent and Trademark Office patent file or records, but otherwise reserve all copyright and mask work rights whatsoever.

### FIELD

The present disclosure is directed generally to marketing platforms.

### BACKGROUND

Businesses use a variety of means to obtain work. Some businesses send out direct mail to advertise their services. Other businesses use online advertisers, such as Google and Bing, to promote their products in search results. Yet other businesses rely on promotions involving discounts to attract customers.

### BRIEF DESCRIPTION OF THE FIGURES

The accompanying figures and/or appendices illustrate various exemplary embodiments in accordance with the present disclosure.

FIG. 1 shows a logic flow diagram illustrating a consumer handling (CH) component in one embodiment of the LSP.

FIG. 2 shows a logic flow diagram illustrating a provider handling (PH) component in one embodiment of the LSP.

FIG. 3 shows a data flow diagram in one embodiment of the LSP.

FIG. 4 shows a block diagram illustrating an exemplary LSP coordinator in one embodiment of the LSP.

APPENDIX 1 appended to U.S. Provisional Patent Application Ser. No. 61/931,138 illustrates additional exemplary embodiments of the LSP.

### DETAILED DESCRIPTION

### Introduction

The LSP introduces a new way of efficiently focusing marketing dollars spent by providers (e.g., of goods and/or services) in a local area. The LSP is the first referral platform that is expandable globally, but focused locally. It provides incentives for potential consumers to refer providers, whom they personally have used, to a locally focused community for use by other consumers, and to add jobs they become aware of to the LSP.

By adding jobs and referring providers, consumers receive incentive vouchers which are redeemable by any LSP provider and which the providers, in turn, can redeem for cash via the LSP. Vouchers are an incentive bridge from one provider to another and, thus, create a more collaborative and cooperative marketing platform that benefits LSP providers.

The LSP includes two mutually dependent communities: a community of providers whose services have been used by, and who may be referred to the LSP by, satisfied consumers, and a community of consumers who have used and referred the services of a provider and who may use such services in the future. It is to be understood that providers can also be consumers.

### Detailed Description of the LSP

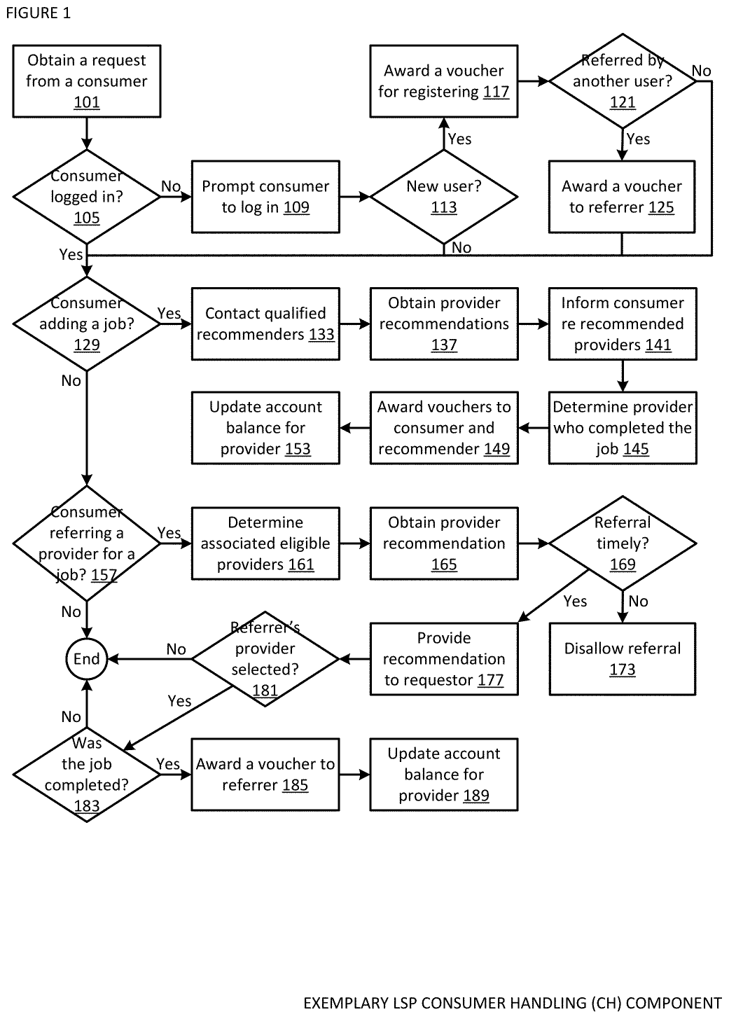

FIG. 1 shows a logic flow diagram illustrating a consumer handling (CH) component in one embodiment of the LSP. In FIG. 1, a request from a consumer may be obtained at 101. In various implementations, the consumer may initiate the request via a mobile app, via a website, and/or the like using the consumer's client (e.g., a desktop, a laptop, a tablet, a smart phone).

A determination may be made at 105 whether the consumer is logged in. In one implementation, a cookie may be used to track whether the consumer is logged into the website. In another implementation, the mobile app may track whether the user provided login information. If the consumer is not logged in, the LSP may prompt the consumer to log in at 109. For example, the consumer may be prompted to provide a user name and a password, or to register.

A determination may be made at 113 whether the consumer is a newly registered user. In one embodiment, newly registered users may be asked to share their personal contacts info (e.g., contacts associated with a user's phone, contacts associated with a user's email account) with the LSP. For example, a user may allow the mobile app to obtain the user's contacts info (e.g., download contacts info stored on the user's phone, obtain contacts info from the user's email account) and/or to identify the user's friends who may be using the LSP. Further, the user may utilize the mobile app to send a message to the user's friends to invite them to join the LSP.

If the consumer is a newly registered user, the LSP may award the consumer a voucher for registering at 117. For example, the LSP may reward newly registered users with a $10 welcome voucher (e.g., paid for by a provider). In one embodiment, vouchers may be used by consumers to pay for goods and/or services at any of the providers associated with the LSP. In another embodiment, consumers may donate their vouchers to charities. In one implementation, data regarding vouchers associated with a user may be stored in the vouchers data store 430e.

A determination may be made at 121 whether the consumer was referred by another user. If the consumer was referred by another user, the LSP may award a voucher to the referrer at 125 for referring the consumer. In some implementations, users may be awarded vouchers for using the LSP (e.g., a user may get a frequent user voucher after a predetermined number of uses of the LSP that result in a transaction, such as enrolling a new user, adding a job that is completed by a LSP provider, referring a provider that completes a job, and/or the like). For example, the referrer may be awarded a $20 frequent user voucher if the referral is the tenth time that the referrer utilized the LSP. In another example, the referrer may be awarded a voucher if the referral is the tenth time that the referrer utilized the LSP, and the value of the voucher may be based on a percentage of the dollar amount of business associated with the referrer's last ten uses of the LSP.

A determination may be made at 129 whether the request is associated with the consumer adding a job (e.g., for the consumer or for another customer) to the LSP. For example, the RequestType field of the request may be examined (e.g., via an XML parser) to make this determination. In one implementation, the job may be added to a list of jobs which the consumer added (e.g., stored in the jobs data store 430c).

If the request is associated with the consumer adding a job (e.g., via an add a job request), qualified recommenders may be contacted at 133. In one embodiment, qualified recommenders may be those users who utilized LSP providers for same or similar category and/or subcategory of job (e.g., tree services: tree removal). In another embodiment, qualified recommenders may have to be located and/or may have to have utilized providers in the customer's local area (e.g., same or nearby zip code, town, county, and/or the like). In yet another embodiment, the customer may specify that qualified recommenders should be those users who are friends with the customer on the LSP. In one implementation, qualified recommenders may be contacted in a predetermined local area (e.g., in the same zip code for companies providing tree services, in the same town for restaurants). In another implementation, local area may vary based on the number of available qualified recommenders (e.g., local area may be adjusted until the number of available qualified recommenders exceeds a predetermined threshold). In various implementations, a qualified recommender may be contacted via a notification message from the mobile app, via an email, via a message from the website, and/or the like. For example, a provider referral request may be sent to a qualified recommender stating that another user wishes to utilize a service that the qualified recommender used previously and/or asking the qualified recommender for a recommendation.

Provider recommendations may be obtained at 137. In one embodiment, jobs for which a user is a qualified recommender may be listed for the user. The user may select a job for which to provide recommendation (e.g., by clicking a “Refer Now” button associated with the job) and recommend one or more providers (e.g., by selecting such providers via a GUI widget) for the selected job. In another embodiment, a user may respond to a provider referral request (e.g., by tapping a notification message) and recommend one or more providers for the associated job.

The LSP may obtain a desired number of provider recommendations from qualified recommenders and inform the consumer regarding the recommended providers at 141. In one implementation, the consumer may be informed (e.g., via a notification message from the mobile app, via an email, via a message from the website) regarding provider recommendations as they are obtained from qualified recommenders. In another implementation, the consumer may be informed regarding provider recommendations once a predetermined number of recommendations (e.g., three recommendations) are obtained and/or once a predetermined period of time (e.g., three days) has elapsed. If the consumer posted the job on behalf of another customer, the customer may be informed regarding the recommended providers instead of or in addition to the consumer. In one embodiment, the consumer may be provided with contact information (e.g., name, address, phone number, email address) of the recommended providers. In another embodiment, the consumer may choose one or more of the recommended providers (e.g., using checkboxes) and send (e.g., via the mobile app) a message (e.g., requesting help with the job, asking for a quote) to each of the chosen providers.

The provider who completed the job may be determined at 145. In one embodiment, upon completion of the job, the provider and/or the customer may inform the LSP that the job was completed (e.g., via a job performed request). In one implementation, the provider and the customer may utilize their clients (e.g., their smart phones) to inform the LSP. For example, NFC capabilities of the clients may be utilized to inform the LSP (e.g., via the mobile app) that the customer's job was completed by the provider. In another example, the customer may indicate that the job was completed (e.g., via the website) and the provider may confirm (e.g., via the mobile app). In one embodiment, information that the job was completed may include an identifier of the provider who completed the job. This information may be parsed (e.g., via an XML parser) to determine the provider who completed the job.

The LSP may award the consumer who added the job and/or the recommender who recommended the provider who completed the job vouchers at 149. Accordingly, consumers may be rewarded for adding jobs to the LSP and recommenders may be rewarded for recommending providers to facilitate the use of the LSP. Furthermore, the consumer, the customer (e.g., if the consumer posted the job on behalf of another customer), the recommender, the provider, and/or the like may be awarded vouchers for using the LSP (e.g., a user may get a frequent user voucher after every tenth use of the LSP that results in a transaction).

The account balance of the provider who completed the job may be updated at 153. In one embodiment, a provider may have to maintain an account (e.g., an escrow account) to pay for vouchers (e.g., for consumers who add jobs that the provider completes, for recommenders who recommend the provider for jobs that the provider completes). In one implementation, the values of the vouchers awarded to the consumer who added the job and/or to the recommender who recommended the provider for the job may be deducted from the provider's account. In another embodiment, the LSP may have an account (e.g., an escrow account) to pay for vouchers (e.g., vouchers issued for using the LSP). In one implementation, the values of the vouchers awarded for using the LSP may be deducted from the LSP's account. In some embodiments, the cost of awarding a voucher (e.g., a voucher for adding a job, a voucher for recommending a provider for a job, a voucher for using the LSP) may be split between a provider and the LSP in any agreed upon way, and account balances for the provider and the LSP may be updated accordingly.

If the request is not associated with the consumer adding a job, a determination may be made at 157 whether the request is associated with the consumer referring a provider for a job (e.g., in response to a provider referral request). For example, the RequestType field of the request may be examined (e.g., via an XML parser) to make this determination. In one implementation, the job may be added to a list of jobs for which the consumer referred a provider (e.g., stored in the referrals data store 430d).

If the request is associated with the consumer referring a provider for a job, associated eligible providers for the consumer may be determined at 161. In one embodiment, eligible providers may be providers, in the same or similar category and/or subcategory as the job, which the consumer used previously. In another embodiment, eligible providers may have to be located in the local area associated with the job (e.g., same or nearby zip code, town, county, and/or the like). In yet another embodiment, eligible providers may have to have a predetermined (e.g., a minimum) account balance associated with their accounts to pay for vouchers.

Provider recommendations may be obtained from the consumer at 165. In one implementation, the consumer may be presented (e.g., via a GUI widget of the mobile app) with a list of eligible providers that the consumer may recommend, and the consumer may select (e.g., by tapping on the desired providers) one or more providers to recommend. In another implementation, the consumer may also be able to provide comments, ratings, reviews, and/or the like associated with the providers that the consumer is recommending. In yet another implementation, the consumer may be able to recommend a provider, but may not be able to include a review of the provider (e.g., to eliminate concern that the review may not be sincere due to the consumer's financial interest in having the provider chosen for the job).

A determination may be made at 169 whether the consumer's referral is timely. In one embodiment, a referral may be timely if the referral is one of a predetermined number of referrals obtained first (e.g., the referral is one of the first three referrals). In another embodiment, a referral may be timely until the job is certified as completed. In yet another embodiment, a referral may be timely until a specified time period (e.g., the referral is timely if the referral is obtained within three days after the job is posted). If the consumer's referral is not timely, the referral may be disallowed at 173.

If the referral is timely, the provider recommended by the consumer may be provided to the requestor (e.g., the consumer who added the job, the customer associated with the job) at 177. In one embodiment, the requestor may be provided with contact information (e.g., via the mobile app, via the website) of the provider recommended by the consumer. In another embodiment, the requestor may be able to obtain additional information (e.g., video about the recommended provider, other services offered by the recommended provider, reviews of the recommended provider by other LSP users) regarding the recommended provider via the LSP (e.g., via the mobile app, via the website).

A determination may be made whether the provider referred by the consumer was selected by the customer to do the job at 181 and whether the job was completed at 183. In one implementation, if the provider referred by the consumer was selected and the provider completed the job, the LSP may be informed by the provider and/or by the customer that the job was completed (e.g., via a job performed request). For example, the Provider field of the job performed request may be examined (e.g., via an XML parser) to determine the identity of the provider who completed the job.

The LSP may award the consumer who referred the provider who completed the job a voucher at 185. Furthermore, the referring consumer, the customer, the provider, and/or the like may be awarded vouchers for using the LSP (e.g., a user may get a frequent user voucher after every tenth use of the LSP that results in a transaction).

The account balance of the provider who completed the job may be updated at 189. In one implementation, the value of the voucher awarded to the consumer who recommended the provider for the job may be deducted from the provider's account. Furthermore, the account balance of the LSP may be updated. In one implementation, the values of the vouchers awarded for using the LSP may be deducted from the LSP's account.

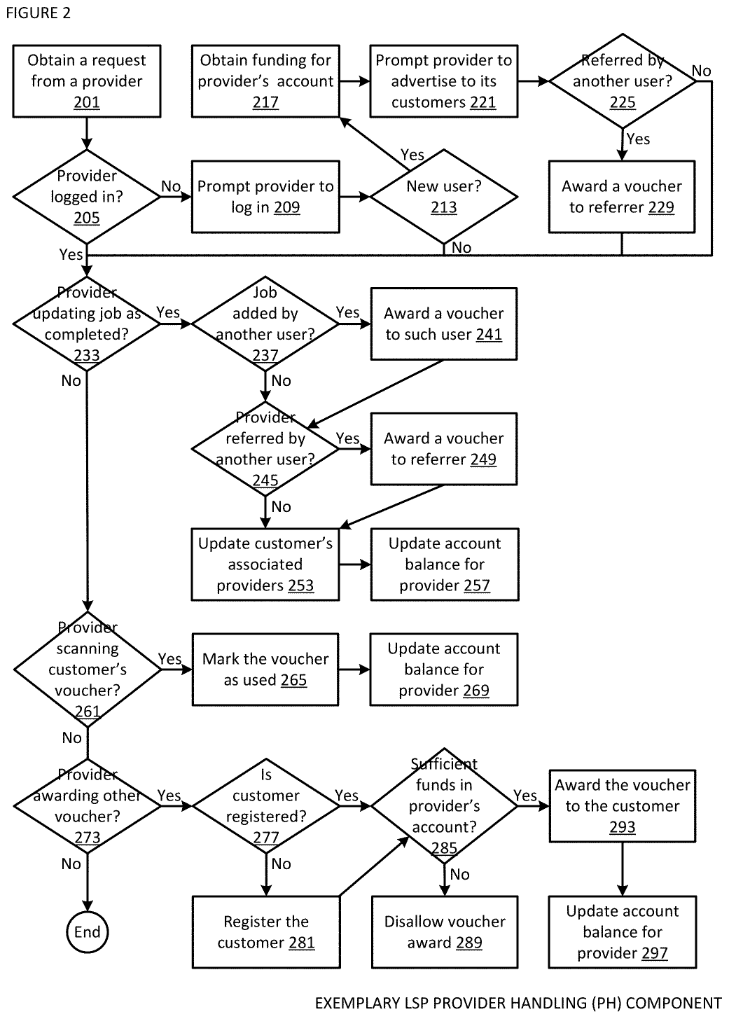

FIG. 2 shows a logic flow diagram illustrating a provider handling (PH) component in one embodiment of the LSP. In FIG. 2, a request from a provider may be obtained at 201. In various implementations, the provider may initiate the request via a mobile app, via a website, and/or the like using the provider's client (e.g., a desktop, a laptop, a tablet, a smart phone).

A determination may be made at 205 whether the provider is logged in. In one implementation, a cookie may be used to track whether the provider is logged into the website. In another implementation, the mobile app may track whether the user provided login information. If the provider is not logged in, the LSP may prompt the provider to log in at 209. For example, the provider may be prompted to provide a user name and a password, or to register.

A determination may be made at 213 whether the provider is a newly registered user. In one embodiment, newly registered providers may be asked to share their customer databases (e.g., a list of the provider's current customers and/or their contact info) with the LSP. For example, the LSP may determine which customers the provider shares with other providers (e.g., to split the cost of awarding a voucher to a consumer for joining the LSP among providers who count the consumer as their customer).

If the provider is a newly registered user, funding for the provider's account and/or a fee may be obtained at 217. In one embodiment, the provider may have to fund an account (e.g., an escrow account) to pay for vouchers. In one implementation, the provider may have to fund the account via a periodic (e.g., monthly) deposit of a predetermined amount (e.g., specified by the provider, specified by the LSP). In another implementation, the provider may have to add funds into the account if the account balance reaches a predetermined threshold (e.g., if the account balance falls below $1,000). In another embodiment, the provider may have to pay a fee to utilize the LSP. In one implementation the provider may have to pay a one-time initial fee. In another implementation, the provider may have to pay a periodic fee (e.g., a monthly fee paid upfront in six month increments).

If the provider is a newly registered user, the provider may be prompted to advertise its use of the LSP at 221. In one embodiment, the provider may be prompted to contact (e.g., via email in a format specified by the LSP) existing and/or previous customers to explain how the LSP works, to request that the customers join the LSP (e.g., by downloading the mobile app and registering with the LSP), to solicit the customers' recommendations on the LSP, and/or the like. In another embodiment, the provider may be prompted to run ads (e.g., TV ads in a format specified by the LSP) in the provider's local area. In some embodiments, the provider may have to have a predetermined (e.g., ten) number of qualified recommenders (e.g., existing and/or new LSP users) to join the LSP. Accordingly, the provider may contact (e.g., via a postcard) existing and/or previous customers to request that the customers join the LSP to allow the provider to satisfy this condition.

A determination may be made at 225 whether the provider was referred by another user. If the provider was referred by another user, the LSP may award a voucher to the referrer at 229 for referring the provider. Furthermore, the referrer may be awarded a voucher for using the LSP (e.g., the referrer may get a frequent user voucher after a predetermined number of uses of the LSP that result in a transaction). For example, the referrer may be awarded a $20 frequent user voucher if the referral is the tenth time that the referrer utilized the LSP. In another example, the referrer may be awarded a voucher if the referral is the tenth time that the referrer utilized the LSP, and the value of the voucher may be based on a percentage of the dollar amount of business associated with the referrer's last ten uses of the LSP. In various embodiments, vouchers may be used by providers to pay for goods and/or services at any of the other providers associated with the LSP, to donate their vouchers to charities, to pay for LSP fees, to replenish the provider's LSP account, and/or the like.

A determination may be made at 233 whether the request is associated with the provider updating a job as completed. For example, the RequestType field of the request (e.g., a job performed request sent by the provider upon completion of the job) may be examined (e.g., via an XML parser) to make this determination.

If the request is associated with the provider updating a job as completed, a determination may be made at 237 whether the job was added by another user (e.g., based on data stored in the referrals data store 430d). If the job was added by another user, the LSP may award such user a voucher at 241.

A determination may be made at 245 whether the provider was referred for the job by another user (e.g., based on data in the referrals data store 430d). If the provider was referred for the job by another user, the LSP may award the referrer a voucher at 249.

Associated providers of the customer associated with the job may be updated at 253. In one embodiment, the customer's associated providers may be those providers that the customer utilized and/or for which the customer is a qualified recommender. In one implementation, if the provider completed a job for the customer, the provider may be associated with the customer.

The account balance of the provider may be updated at 257. In one implementation, the values of the vouchers awarded to the user who added the job and/or to the referrer who recommended the provider for the job may be deducted from the provider's account. Furthermore, the account balance of the LSP may be updated. In one implementation, the values of the vouchers awarded for using the LSP may be deducted from the LSP's account.

If the request is not associated with the provider updating a job as completed, a determination may be made at 261 whether the request is associated with the provider scanning a customer's voucher. For example, the RequestType field of the request may be examined (e.g., via an XML parser) to make this determination. In one embodiment, vouchers may be used by customers to pay for goods and/or services at any of the providers associated with the LSP.

If the request is associated with the provider scanning a customer's voucher, the voucher may be marked as used at 265. In one embodiment, the LSP may keep track of who paid for the voucher, who was awarded the voucher, who redeemed the voucher, monetary amounts associated with the voucher (how much was awarded, how much was spent, how much was donated), dates and/or times associated with the voucher (e.g., when received, when spent), and/or the like to facilitate reporting features (e.g., reports on voucher usage) of the LSP.

The account balance of the provider may be updated at 269. In one implementation, the value of the voucher redeemed by the customer may be debited against the provider's account.

If the request is not associated with the provider scanning a customer's voucher, a determination may be made at 273 whether the request is associated with the provider awarding a customer a voucher for reasons other than referrals (e.g., for writing a review, for purchasing from the provider a specified number of times). For example, the RequestType field of the request may be examined (e.g., via an XML parser) to make this determination. In one embodiment, vouchers may be used by customers to pay for goods and/or services at any of the providers associated with the LSP.

A determination may be made at 277 whether the customer is registered with the LSP. If the customer is not registered, the provider and/or the customer may be prompted to register with the LSP at 281. In one embodiment, a user may not be awarded vouchers (e.g., for referrals, for reasons other than referrals) unless the user is registered with the LSP.

A determination may be made at 285 whether there are sufficient funds in the provider's account to pay for the voucher (e.g., based on data in the accounts data store 430f). If there are insufficient funds, the voucher award may be disallowed at 289. If there are sufficient funds, the voucher may be awarded to the customer at 293. The account balance of the provider may be updated at 297. In one implementation, the value of the voucher awarded to the customer may be deducted from the provider's account.

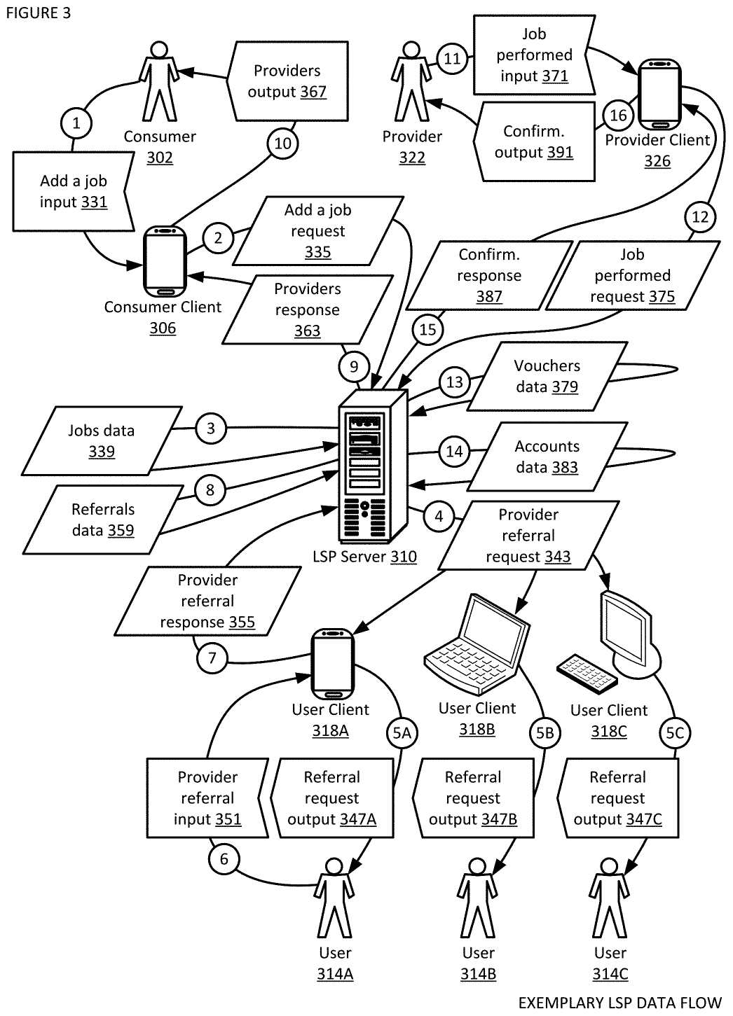

FIG. 3 shows a data flow diagram in one embodiment of the LSP. FIG. 3 provides an example of how data may flow to, through, and/or from the LSP. In FIG. 3, a consumer 302 may wish to add a job to the LSP. The consumer may input information regarding the job 331 via the consumer's client 306. For example, the consumer may type in information regarding the job via the client's touchscreen.

The consumer's client may send an add a job request 335 to a LSP server 310. The add a job request may instruct the LSP server to add the job to a pool of jobs. For example, the add a job request may include data such as consumer identifier, contact details, job identifier, job description, job category, job subcategory, job location, job added date and/or time, and/or the like.

The LSP server may analyze jobs data 339. The LSP server may add the job to the pool of jobs, determine qualified recommenders for the job, set an expiration date for removing the job from the pool of jobs, and/or the like.

The LSP server may send a provider referral request 343 to qualified recommenders 314A-C via their respective clients 318A-C. The provider referral request may solicit provider recommendations from the qualified recommenders. For example, the provider referral request may include data such as referrer identifier, job description, job category, job subcategory, referrer's associated eligible providers, voucher award value, and/or the like.

User 314A may input a provider referral 351 via the user's client 318A. For example, the user may select one or more associated eligible providers to recommend for the job. Furthermore, the user may input comments, ratings, reviews, and/or the like associated with the providers that the user is recommending. It is to be understood that any LSP user can be a consumer, a provider, or both a consumer and a provider.

The user's client may send a provider referral response 355 to the LSP server. The provider referral response may include information regarding providers referred by the user for the job and may instruct the LSP server to add the referral to a list of referrals. For example the provider referral response may include data such as referrer identifier, recommended provider identifier, comments about recommended provider, job identifier, and/or the like.

The LSP server may analyze referrals data 359. The LSP server may determine whether the referral is timely, add the referral to the list of referrals, add the recommended provider to a list of recommended providers to send to the consumer, and/or the like.

The LSP server may send a providers response 363 to the consumer's client. The providers response may include information regarding providers recommended by the referrers. For example, the providers response may include data such as consumer identifier, job identifier, recommended provider identifier, comments about recommended provider, description of recommended provider, contact information of recommended provider, and/or the like.

The consumer's client may output information regarding recommended providers 367 to the consumer. For example, the client may display such information on the client's screen, may facilitate contacting one or more recommended providers, and/or the like.

A provider 322 may indicate via job performed input 371 that the provider completed the job via the provider's client 326. For example, the provider may utilize a GUI widget of a mobile app to indicate that the provider completed the job.

The provider's client may send a job performed request 375 to inform the LSP server that the provider completed the job. For example, the job performed request may include data such as job identifier, provider identifier, identifiers of vouchers redeemed, date and/or time when the job was marked as completed, and/or the like.

The LSP server may analyze vouchers data 379. The LSP server may determine who should be awarded vouchers for adding the job and/or for referring the provider who completed the job and/or for using the LSP, values of vouchers that should be awarded, which vouchers were redeemed by the customer associated with the job and should be marked as used, and/or the like.

The LSP server may analyze accounts data 383. The LSP server may determine how to adjust account balances of the provider who completed the job and/or of the LSP, whether the provider's account should be replenished, and/or the like.

The LSP server may send a confirmation response 387 to the provider's client. The confirmation response may confirm that the job performed request was handled correctly. The provider's client may display confirmation output 391 to the provider. For example, the client may display a message thanking the provider for completing the job.

APPENDIX 1 illustrates additional exemplary embodiments of the LSP.

### Detailed Description of the LSP Coordinator

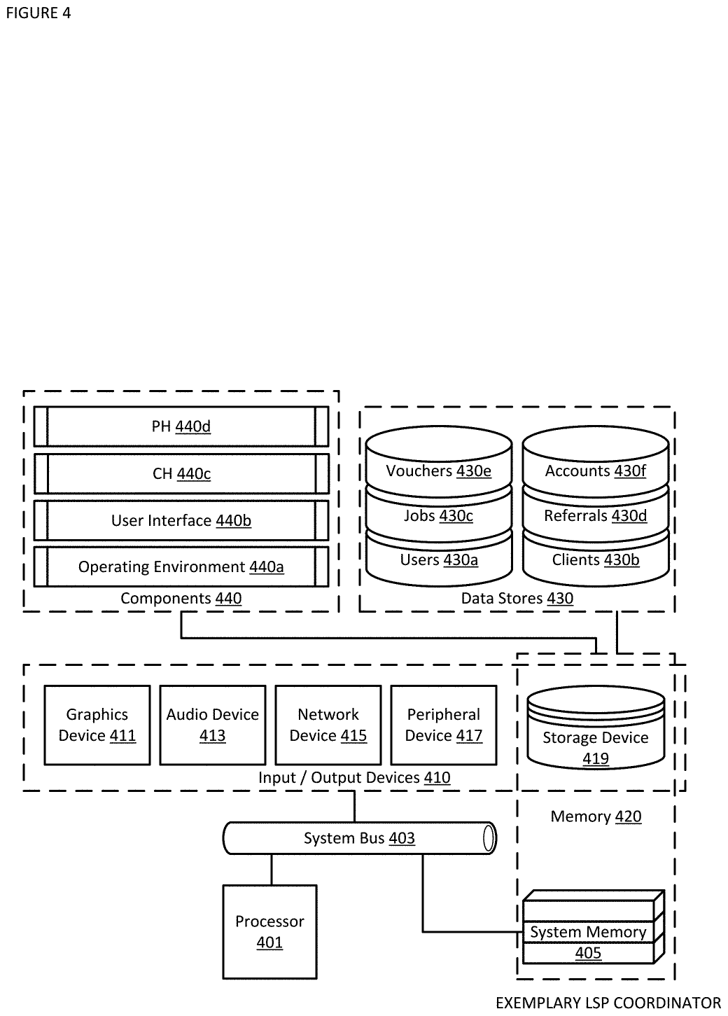

FIG. 4 shows a block diagram illustrating an exemplary LSP coordinator in one embodiment of the LSP. The LSP coordinator facilitates the operation of the LSP via a computer system (e.g., one or more cloud computing systems, grid computing systems, virtualized computer systems, mainframe computers, servers, clients, nodes, desktops, mobile devices such as smart phones, cellular phones, tablets, personal digital assistants (PDAs), and/or the like, embedded computers, dedicated computers, a system on a chip (SOC)). For example, the LSP coordinator may receive, obtain, aggregate, process, generate, store, retrieve, send, delete, input, output, and/or the like data (including program data and program instructions); may execute program instructions; may communicate with computer systems, with nodes, with users, and/or the like. In various embodiments, the LSP coordinator may comprise a standalone computer system, a distributed computer system, a node in a computer network (i.e., a network of computer systems organized in a topology), a network of LSP coordinators, and/or the like. It is to be understood that the LSP coordinator and/or the various LSP coordinator elements (e.g., processor, system bus, memory, input/output devices) may be organized in any number of ways (i.e., using any number and configuration of computer systems, computer networks, nodes, LSP coordinator elements, and/or the like) to facilitate LSP operation. Furthermore, it is to be understood that the various LSP coordinator computer systems, LSP coordinator computer networks, LSP coordinator nodes, LSP coordinator elements, and/or the like may communicate among each other in any number of ways to facilitate LSP operation. As used in this disclosure, the term “user” refers generally to people and/or computer systems that interact with the LSP; the term “server” refers generally to a computer system, a program, and/or a combination thereof that handles requests and/or responds to requests from clients via a computer network; the term “client” refers generally to a computer system, a program, a user, and/or a combination thereof that generates requests and/or handles responses from servers via a computer network; the term “node” refers generally to a server, to a client, and/or to an intermediary computer system, program, and/or a combination thereof that facilitates transmission of and/or handling of requests and/or responses.

The LSP coordinator includes a processor 401 that executes program instructions (e.g., LSP program instructions). In various embodiments, the processor may be a general purpose microprocessor (e.g., a central processing unit (CPU)), a dedicated microprocessor (e.g., a graphics processing unit (GPU), a physics processing unit (PPU), a digital signal processor (DSP), a network processor, and/or the like), an external processor, a plurality of processors (e.g., working in parallel, distributed, and/or the like), a microcontroller (e.g., for an embedded system), and/or the like. The processor may be implemented using integrated circuits (ICs), application-specific integrated circuits (ASICs), field-programmable gate arrays (FPGAs), and/or the like. In various implementations, the processor may comprise one or more cores, may include embedded elements (e.g., a coprocessor such as a math coprocessor, a cryptographic coprocessor, a physics coprocessor, and/or the like, registers, cache memory, software), may be synchronous (e.g., using a clock signal) or asynchronous (e.g., without a central clock), and/or the like. For example, the processor may be an AMD FX processor, an AMD Opteron processor, an AMD Geode LX processor, an Intel Core i7 processor, an Intel Xeon processor, an Intel Atom processor, an ARM Cortex processor, an IBM PowerPC processor, and/or the like.

The processor may be connected to system memory 405 via a system bus 403. The system bus may interconnect these and/or other elements of the LSP coordinator via electrical, electronic, optical, wireless, and/or the like communication links (e.g., the system bus may be integrated into a motherboard that interconnects LSP coordinator elements and provides power from a power supply). In various embodiments, the system bus may comprise one or more control buses, address buses, data buses, memory buses, peripheral buses, and/or the like. In various implementations, the system bus may be a parallel bus, a serial bus, a daisy chain design, a hub design, and/or the like. For example, the system bus may comprise a front-side bus, a back-side bus, AMD's HyperTransport, Intel's QuickPath Interconnect, a peripheral component interconnect (PCI) bus, an accelerated graphics port (AGP) bus, a PCI Express bus, a low pin count (LPC) bus, a universal serial bus (USB), and/or the like. The system memory, in various embodiments, may comprise registers, cache memory (e.g., level one, level two, level three), read only memory (ROM) (e.g., BIOS, flash memory), random access memory (RAM) (e.g., static RAM (SRAM), dynamic RAM (DRAM), error-correcting code (ECC) memory), and/or the like. The system memory may be discreet, external, embedded, integrated into a CPU, and/or the like. The processor may access, read from, write to, store in, erase, modify, and/or the like, the system memory in accordance with program instructions (e.g., LSP program instructions) executed by the processor. The system memory may facilitate accessing, storing, retrieving, modifying, deleting, and/or the like data (e.g., LSP data) by the processor.

In various embodiments, input/output devices 410 may be connected to the processor and/or to the system memory, and/or to one another via the system bus.

In some embodiments, the input/output devices may include one or more graphics devices 411. The processor may make use of the one or more graphic devices in accordance with program instructions (e.g., LSP program instructions) executed by the processor. In one implementation, a graphics device may be a video card that may obtain (e.g., via a connected video camera), process (e.g., render a frame), output (e.g., via a connected monitor, television, and/or the like), and/or the like graphical (e.g., multimedia, video, image, text) data (e.g., LSP data). A video card may be connected to the system bus via an interface such as PCI, AGP, PCI Express, USB, PC Card, ExpressCard, and/or the like. A video card may use one or more graphics processing units (GPUs), for example, by utilizing AMD's CrossFireX and/or NVIDIA's SLI technologies. A video card may be connected via an interface (e.g., video graphics array (VGA), digital video interface (DVI), Mini-DVI, Micro-DVI, high-definition multimedia interface (HDMI), DisplayPort, Thunderbolt, composite video, S-Video, component video, and/or the like) to one or more displays (e.g., cathode ray tube (CRT), liquid crystal display (LCD), touchscreen, and/or the like) that display graphics. For example, a video card may be an AMD Radeon HD 6990, an ATI Mobility Radeon HD 5870, an AMD FirePro V9800P, an AMD Radeon E6760 MXM V3.0 Module, an NVIDIA GeForce GTX 590, an NVIDIA GeForce GTX 580M, an Intel HD Graphics 3000, and/or the like. In another implementation, a graphics device may be a video capture board that may obtain (e.g., via coaxial cable), process (e.g., overlay with other graphical data), capture, convert (e.g., between different formats, such as MPEG2 to H.264), and/or the like graphical data. A video capture board may be and/or include a TV tuner, may be compatible with a variety of broadcast signals (e.g., NTSC, PAL, ATSC, QAM) may be a part of a video card, and/or the like. For example, a video capture board may be an ATI All-in-Wonder HD, a Hauppauge ImpactVBR 01381, a Hauppauge WinTV-HVR-2250, a Hauppauge Colossus 01414, and/or the like. A graphics device may be discreet, external, embedded, integrated into a CPU, and/or the like. A graphics device may operate in combination with other graphics devices (e.g., in parallel) to provide improved capabilities, data throughput, color depth, and/or the like.

In some embodiments, the input/output devices may include one or more audio devices 413. The processor may make use of the one or more audio devices in accordance with program instructions (e.g., LSP program instructions) executed by the processor. In one implementation, an audio device may be a sound card that may obtain (e.g., via a connected microphone), process, output (e.g., via connected speakers), and/or the like audio data (e.g., LSP data). A sound card may be connected to the system bus via an interface such as PCI, PCI Express, USB, PC Card, ExpressCard, and/or the like. A sound card may be connected via an interface (e.g., tip sleeve (TS), tip ring sleeve (TRS), RCA, TOSLINK, optical) to one or more amplifiers, speakers (e.g., mono, stereo, surround sound), subwoofers, digital musical instruments, and/or the like. For example, a sound card may be an Intel AC '97 integrated codec chip, an Intel HD Audio integrated codec chip, a Creative Sound Blaster X-Fi Titanium HD, a Creative Sound Blaster X-Fi Go! Pro, a Creative Sound Blaster Recon 3D, a Turtle Beach Riviera, a Turtle Beach Amigo II, and/or the like. An audio device may be discreet, external, embedded, integrated into a motherboard, and/or the like. An audio device may operate in combination with other audio devices (e.g., in parallel) to provide improved capabilities, data throughput, audio quality, and/or the like.

In some embodiments, the input/output devices may include one or more network devices 415. The processor may make use of the one or more network devices in accordance with program instructions (e.g., LSP program instructions) executed by the processor. In one implementation, a network device may be a network card that may obtain (e.g., via a Category 5 Ethernet cable), process, output (e.g., via a wireless antenna), and/or the like network data (e.g., LSP data). A network card may be connected to the system bus via an interface such as PCI, PCI Express, USB, FireWire, PC Card, ExpressCard, and/or the like. A network card may be a wired network card (e.g., 10/100/1000, optical fiber), a wireless network card (e.g., Wi-Fi 802.11a/b/g/n/ac/ad, Bluetooth, Near Field Communication (NFC), TransferJet), a modem (e.g., dialup telephone-based, asymmetric digital subscriber line (ADSL), cable modem, power line modem, wireless modem based on cellular protocols such as high speed packet access (HSPA), evolution-data optimized (EV-DO), global system for mobile communications (GSM), worldwide interoperability for microwave access (WiMax), long term evolution (LTE), and/or the like, satellite modem, FM radio modem, radio-frequency identification (RFID) modem, infrared (IR) modem), and/or the like. For example, a network card may be an Intel EXPI9301CT, an Intel EXPI9402PT, a LINKSYS USB300M, a BUFFALO WLI-UC-G450, a Rosewill RNX-MiniN1, a TRENDnet TEW-623PI, a Rosewill RNX-N180UBE, an ASUS USB-BT211, a MOTOROLA SB6120, a U.S. Robotics USR5686G, a Zoom 5697-00-00F, a TRENDnet TPL-401E2K, a D-Link DHP-W306AV, a StarTech ET91000SC, a Broadcom BCM20791, a Broadcom InConcert BCM4330, a Broadcom BCM4360, an LG VL600, a Qualcomm MDM9600, a Toshiba TC35420 TransferJet device, and/or the like. A network device may be discreet, external, embedded, integrated into a motherboard, and/or the like. A network device may operate in combination with other network devices (e.g., in parallel) to provide improved data throughput, redundancy, and/or the like. For example, protocols such as link aggregation control protocol (LACP) based on IEEE 802.3AD-2000 or IEEE 802.1AX-2008 standards may be used. A network device may be used to connect to a local area network (LAN), a wide area network (WAN), a metropolitan area network (MAN), a personal area network, the Internet, an intranet, a Bluetooth network, an NFC network, a Wi-Fi network, a cellular network, and/or the like.

In some embodiments, the input/output devices may include one or more peripheral devices 417. The processor may make use of the one or more peripheral devices in accordance with program instructions (e.g., LSP program instructions) executed by the processor. In various implementations, a peripheral device may be a digital camera, a video camera, a webcam, an electronically moveable pan tilt zoom (PTZ) camera, a monitor, a touchscreen display, active shutter 3D glasses, head-tracking 3D glasses, a remote control, an audio line-in, an audio line-out, a microphone, headphones, speakers, a subwoofer, a router, a hub, a switch, a firewall, an antenna, a keyboard, a mouse, a trackpad, a trackball, a digitizing tablet, a stylus, a joystick, a gamepad, a game controller, a force-feedback device, a laser, sensors (e.g., proximity sensor, rangefinder, ambient temperature sensor, ambient light sensor, humidity sensor, an accelerometer, a gyroscope, a motion sensor, an olfaction sensor, a biosensor, a chemical sensor, a magnetometer, a radar, a sonar, a location sensor such as global positioning system (GPS), Galileo, GLONASS, and/or the like), a printer, a fax, a scanner, a copier, a card reader, and/or the like. A peripheral device may be connected to the system bus via an interface such as PCI, PCI Express, USB, FireWire, VGA, DVI, Mini-DVI, Micro-DVI, HDMI, DisplayPort, Thunderbolt, composite video, S-Video, component video, PC Card, ExpressCard, serial port, parallel port, PS/2, TS, TRS, RCA, TOSLINK, network connection (e.g., wired such as Ethernet, optical fiber, and/or the like, wireless such as Wi-Fi, Bluetooth, NFC, cellular, and/or the like), a connector of another input/output device, and/or the like. A peripheral device may be discreet, external, embedded, integrated (e.g., into a processor, into a motherboard), and/or the like. A peripheral device may operate in combination with other peripheral devices (e.g., in parallel) to provide the LSP coordinator with a variety of input, output and processing capabilities.

In some embodiments, the input/output devices may include one or more storage devices 419. The processor may access, read from, write to, store in, erase, modify, and/or the like a storage device in accordance with program instructions (e.g., LSP program instructions) executed by the processor. A storage device may facilitate accessing, storing, retrieving, modifying, deleting, and/or the like data (e.g., LSP data) by the processor. In one implementation, the processor may access data from the storage device directly via the system bus. In another implementation, the processor may access data from the storage device by instructing the storage device to transfer the data to the system memory and accessing the data from the system memory. In various embodiments, a storage device may be a hard disk drive (HDD), a solid-state drive (SSD), a floppy drive using diskettes, an optical disk drive (e.g., compact disk (CD-ROM) drive, CD-Recordable (CD-R) drive, CD-Rewriteable (CD-RW) drive, digital versatile disc (DVD-ROM) drive, DVD-R drive, DVD-RW drive, Blu-ray disk (BD) drive) using an optical medium, a magnetic tape drive using a magnetic tape, a memory card (e.g., a USB flash drive, a compact flash (CF) card, a secure digital extended capacity (SDXC) card), a network attached storage (NAS), a direct-attached storage (DAS), a storage area network (SAN), other processor-readable physical mediums, and/or the like. A storage device may be connected to the system bus via an interface such as PCI, PCI Express, USB, FireWire, PC Card, ExpressCard, integrated drive electronics (IDE), serial advanced technology attachment (SATA), external SATA (eSATA), small computer system interface (SCSI), serial attached SCSI (SAS), fibre channel (FC), network connection (e.g., wired such as Ethernet, optical fiber, and/or the like; wireless such as Wi-Fi, Bluetooth, NFC, cellular, and/or the like), and/or the like. A storage device may be discreet, external, embedded, integrated (e.g., into a motherboard, into another storage device), and/or the like. A storage device may operate in combination with other storage devices to provide improved capacity, data throughput, data redundancy, and/or the like. For example, protocols such as redundant array of independent disks (RAID) (e.g., RAID 0 (striping), RAID 1 (mirroring), RAID 5 (striping with distributed parity), hybrid RAID), just a bunch of drives (JBOD), and/or the like may be used. In another example, virtual and/or physical drives may be pooled to create a storage pool. In yet another example, an SSD cache may be used with a HDD to improve speed.

Together and/or separately the system memory 405 and the one or more storage devices 419 may be referred to as memory 420 (i.e., physical memory).

LSP memory 420 contains processor-operable (e.g., accessible) LSP data stores 430. Data stores 430 comprise data that may be used (e.g., by the LSP) via the LSP coordinator. Such data may be organized using one or more data formats such as a database (e.g., a relational database with database tables, an object-oriented database, a graph database, a hierarchical database), a flat file (e.g., organized into a tabular format), a binary file (e.g., a GIF file, an MPEG-4 file), a structured file (e.g., an HTML file, an XML file), a text file, and/or the like. Furthermore, data may be organized using one or more data structures such as an array, a queue, a stack, a set, a linked list, a map, a tree, a hash, a record, an object, a directed graph, and/or the like. In various embodiments, data stores may be organized in any number of ways (i.e., using any number and configuration of data formats, data structures, LSP coordinator elements, and/or the like) to facilitate LSP operation. For example, LSP data stores may comprise data stores 430a-f implemented as one or more databases. A users data store 430a may be a collection of database tables that include fields such as UserID, UserName, UserPreferences, AssociatedProviders, and/or the like. A clients data store 430b may be a collection of database tables that include fields such as ClientID, ClientName, ClientDeviceType, ClientScreenResolution, and/or the like. A jobs data store 430c may be a collection of database tables that include fields such as JobID, JobDescription, JobCategory, JobSubCategory, JobAddedDateTime, JobConsumerID, JobProviderID, IsJobCompleted, and/or the like. A referrals data store 430d may be a collection of database tables that include fields such as ReferralID, ReferrerID, ReferralType, AssociatedJobID, AssociatedUserID, VoucherAwardAmount, IsVoucherEarned, and/or the like. A vouchers data store 430e may be a collection of database tables that include fields such as VoucherID, AssociatedConsumerID, AssociatedProviderID, AssociatedVendorID, AssociatedCharityID, VoucherAmount, IsVoucherUsed, and/or the like. An accounts data store 430f may be a collection of database tables that include fields such as AccountID, AssociatedUserID, AccountBalance, AccountPreferences, and/or the like. The LSP coordinator may use data stores 430 to keep track of inputs, parameters, settings, variables, records, outputs, and/or the like.

LSP memory 420 contains processor operable (e.g., executable) LSP components 440. Components 440 comprise program components (including program instructions and any associated data stores) that are executed (e.g., by the LSP) via the LSP coordinator (i.e., via the processor) to transform LSP inputs into LSP outputs. It is to be understood that the various components and their subcomponents, capabilities, applications, and/or the like may be organized in any number of ways (i.e., using any number and configuration of components, subcomponents, capabilities, applications, LSP coordinator elements, and/or the like) to facilitate LSP operation. Furthermore, it is to be understood that the various components and their subcomponents, capabilities, applications, and/or the like may communicate among each other in any number of ways to facilitate LSP operation. For example, the various components and their subcomponents, capabilities, applications, and/or the like may be combined, integrated, consolidated, split up, distributed, and/or the like in any number of ways to facilitate LSP operation. In another example, a single or multiple instances of the various components and their subcomponents, capabilities, applications, and/or the like may be instantiated on each of a single LSP coordinator node, across multiple LSP coordinator nodes, and/or the like.

In various embodiments, program components may be developed using one or more programming languages, techniques, tools, and/or the like such as an assembly language, Ada, BASIC, C, C++, C#, COBOL, Fortran, Java, LabVIEW, Lisp, Mathematica, MATLAB, OCaml, PL/I, Smalltalk, Visual Basic for Applications (VBA), HTML, XML, CSS, JavaScript, JavaScript Object Notation (JSON), PHP, Perl, Ruby, Python, Asynchronous JavaScript and XML (AJAX), Simple Object Access Protocol (SOAP), SSL, ColdFusion, Microsoft .NET, Apache modules, Adobe Flash, Adobe AIR, Microsoft Silverlight, Windows PowerShell, batch files, Tcl, graphical user interface (GUI) toolkits, SQL, database adapters, web application programming interfaces (APIs), application server extensions, integrated development environments (IDEs), libraries (e.g., object libraries, class libraries, remote libraries), remote procedure calls (RPCs), Common Object Request Broker Architecture (CORBA), and/or the like.

In some embodiments, components 440 may include an operating environment component 440a. The operating environment component may facilitate operation of the LSP via various subcomponents.

In some implementations, the operating environment component may include an operating system subcomponent. The operating system subcomponent may provide an abstraction layer that facilitates the use of, communication among, common services for, interaction with, security of, and/or the like of various LSP coordinator elements, components, data stores, and/or the like.

In some embodiments, the operating system subcomponent may facilitate execution of program instructions (e.g., LSP program instructions) by the processor by providing process management capabilities. For example, the operating system subcomponent may facilitate the use of multiple processors, the execution of multiple processes, multitasking, and/or the like.

In some embodiments, the operating system subcomponent may facilitate the use of memory by the LSP. For example, the operating system subcomponent may allocate and/or free memory, facilitate memory addressing, provide memory segmentation and/or protection, provide virtual memory capability, facilitate caching, and/or the like. In another example, the operating system subcomponent may include a file system (e.g., File Allocation Table (FAT), New Technology File System (NTFS), Hierarchical File System Plus (HFS+), Universal Disk Format (UDF), Linear Tape File System (LTFS)) to facilitate storage, retrieval, deletion, aggregation, processing, generation, and/or the like of data.

In some embodiments, the operating system subcomponent may facilitate operation of and/or processing of data for and/or from input/output devices. For example, the operating system subcomponent may include one or more device drivers, interrupt handlers, file systems, and/or the like that allow interaction with input/output devices.

In some embodiments, the operating system subcomponent may facilitate operation of the LSP coordinator as a node in a computer network by providing support for one or more communications protocols. For example, the operating system subcomponent may include support for the internet protocol suite (i.e., Transmission Control Protocol/Internet Protocol (TCP/IP)) of network protocols such as TCP, IP, User Datagram Protocol (UDP), Mobile IP, and/or the like. In another example, the operating system subcomponent may include support for security protocols (e.g., Wired Equivalent Privacy (WEP), Wi-Fi Protected Access (WPA), WPA2) for wireless computer networks. In yet another example, the operating system subcomponent may include support for virtual private networks (VPNs).

In some embodiments, the operating system subcomponent may facilitate security of the LSP coordinator. For example, the operating system subcomponent may provide services such as authentication, authorization, audit, network intrusion-detection capabilities, firewall capabilities, antivirus capabilities, and/or the like.

In some embodiments, the operating system subcomponent may facilitate user interaction with the LSP by providing user interface elements that may be used by the LSP to generate a user interface. In one implementation, such user interface elements may include widgets (e.g., windows, dialog boxes, scrollbars, menu bars, tabs, ribbons, menus, buttons, text boxes, checkboxes, combo boxes, drop-down lists, list boxes, radio buttons, sliders, spinners, grids, labels, progress indicators, icons, tooltips, and/or the like) that may be used to obtain input from and/or provide output to the user. For example, such widgets may be used via a widget toolkit such as Microsoft Foundation Classes (MFC), Apple Cocoa Touch, Java Swing, GTK+, Qt, Yahoo! User Interface Library (YUI), and/or the like. In another implementation, such user interface elements may include sounds (e.g., event notification sounds stored in MP3 file format), animations, vibrations, and/or the like that may be used to inform the user regarding occurrence of various events. For example, the operating system subcomponent may include a user interface such as Windows Aero, Mac OS X Aqua, GNOME Shell, KDE Plasma Workspaces (e.g., Plasma Desktop, Plasma Netbook, Plasma Contour, Plasma Mobile), and/or the like.

In various embodiments the operating system subcomponent may comprise a single-user operating system, a multi-user operating system, a single-tasking operating system, a multitasking operating system, a single-processor operating system, a multiprocessor operating system, a distributed operating system, an embedded operating system, a real-time operating system, and/or the like. For example, the operating system subcomponent may comprise an operating system such as UNIX, LINUX, IBM i, Sun Solaris, Microsoft Windows Server, Microsoft DOS, Microsoft Windows 7, Microsoft Windows 8, Apple Mac OS X, Apple iOS, Android, Symbian, Windows Phone 7, Windows Phone 8, Blackberry QNX, and/or the like.

In some implementations, the operating environment component may include a database subcomponent. The database subcomponent may facilitate LSP capabilities such as storage, analysis, retrieval, access, modification, deletion, aggregation, generation, and/or the like of data (e.g., the use of data stores 430). The database subcomponent may make use of database languages (e.g., Structured Query Language (SQL), XQuery), stored procedures, triggers, APIs, and/or the like to provide these capabilities. In various embodiments the database subcomponent may comprise a cloud database, a data warehouse, a distributed database, an embedded database, a parallel database, a real-time database, and/or the like. For example, the database subcomponent may comprise a database such as Microsoft SQL Server, Microsoft Access, MySQL, IBM DB2, Oracle Database, and/or the like.

In some implementations, the operating environment component may include an information handling subcomponent. The information handling subcomponent may provide the LSP with capabilities to serve, deliver, upload, obtain, present, download, and/or the like a variety of information. The information handling subcomponent may use protocols such as Hypertext Transfer Protocol (HTTP), Hypertext Transfer Protocol Secure (HTTPS), File Transfer Protocol (FTP), Telnet, Secure Shell (SSH), Transport Layer Security (TLS), Secure Sockets Layer (SSL), peer-to-peer (P2P) protocols (e.g., BitTorrent), and/or the like to handle communication of information such as web pages, files, multimedia content (e.g., streaming media), applications, and/or the like.

In some embodiments, the information handling subcomponent may facilitate the serving of information to users, LSP components, nodes in a computer network, web browsers, and/or the like. For example, the information handling subcomponent may comprise a web server such as Apache HTTP Server, Microsoft Internet Information Services (IIS), Oracle WebLogic Server, Adobe Flash Media Server, Adobe Content Server, and/or the like. Furthermore, a web server may include extensions, plug-ins, add-ons, servlets, and/or the like. For example, these may include Apache modules, IIS extensions, Java servlets, and/or the like. In some implementations, the information handling subcomponent may communicate with the database subcomponent via standards such as Open Database Connectivity (ODBC), Java Database Connectivity (JDBC), ActiveX Data Objects for .NET (ADO.NET), and/or the like. For example, the information handling subcomponent may use such standards to store, analyze, retrieve, access, modify, delete, aggregate, generate, and/or the like data (e.g., data from data stores 430) via the database subcomponent.

In some embodiments, the information handling subcomponent may facilitate presentation of information obtained from users, LSP components, nodes in a computer network, web servers, and/or the like. For example, the information handling subcomponent may comprise a web browser such as Microsoft Internet Explorer, Mozilla Firefox, Apple Safari, Google Chrome, Opera Mobile, Amazon Silk, Nintendo 3DS Internet Browser, and/or the like. Furthermore, a web browser may include extensions, plug-ins, add-ons, applets, and/or the like. For example, these may include Adobe Flash Player, Adobe Acrobat plug-in, Microsoft Silverlight plug-in, Microsoft Office plug-in, Java plug-in, and/or the like.

In some implementations, the operating environment component may include a messaging subcomponent. The messaging subcomponent may facilitate LSP message communications capabilities. The messaging subcomponent may use protocols such as Simple Mail Transfer Protocol (SMTP), Internet Message Access Protocol (IMAP), Post Office Protocol (POP), Extensible Messaging and Presence Protocol (XMPP), Real-time Transport Protocol (RTP), Internet Relay Chat (IRC), Skype protocol, AOL's Open System for Communication in Realtime (OSCAR), Messaging Application Programming Interface (MAPI), Facebook API, a custom protocol, and/or the like to facilitate LSP message communications. The messaging subcomponent may facilitate message communications such as email, instant messaging, Voice over IP (VoIP), video conferencing, Short Message Service (SMS), web chat, in-app messaging (e.g., alerts, notifications), and/or the like. For example, the messaging subcomponent may comprise Microsoft Exchange Server, Microsoft Outlook, Sendmail, IBM Lotus Domino, Gmail, AOL Instant Messenger (AIM), Yahoo Messenger, ICQ, Trillian, Skype, Google Talk, Apple FaceTime, Apple iChat, Facebook Chat, and/or the like.

In some implementations, the operating environment component may include a security subcomponent that facilitates LSP security. In some embodiments, the security subcomponent may restrict access to the LSP, to one or more services provided by the LSP, to data associated with the LSP (e.g., stored in data stores 430), to communication messages associated with the LSP, and/or the like to authorized users. Access may be granted via a login screen, via an API that obtains authentication information, via an authentication token, and/or the like. For example, the user may obtain access by providing a username and/or a password (e.g., a string of characters, a picture password), a personal identification number (PIN), an identification card, a magnetic stripe card, a smart card, a biometric identifier (e.g., a finger print, a voice print, a retina scan, a face scan), a gesture (e.g., a swipe), a media access control (MAC) address, an IP address, and/or the like. Various security models such as access-control lists (ACLs), capability-based security, hierarchical protection domains, and/or the like may be used to control access. For example, the security subcomponent may facilitate digital rights management (DRM), network intrusion detection, firewall capabilities, and/or the like.

In some embodiments, the security subcomponent may use cryptographic techniques to secure information (e.g., by storing encrypted data), verify message authentication (e.g., via a digital signature), provide integrity checking (e.g., a checksum), and/or the like by facilitating encryption and/or decryption of data. Furthermore, steganographic techniques may be used instead of or in combination with cryptographic techniques. Cryptographic techniques used by the LSP may include symmetric key cryptography using shared keys (e.g., using one or more block ciphers such as triple Data Encryption Standard (DES), Advanced Encryption Standard (AES); stream ciphers such as Rivest Cipher 4 (RC4), Rabbit), asymmetric key cryptography using a public key/private key pair (e.g., using algorithms such as Rivest-Shamir-Adleman (RSA), Digital Signature Algorithm (DSA)), cryptographic hash functions (e.g., using algorithms such as Message-Digest 5 (MD5), Secure Hash Algorithm 2 (SHA-2)), and/or the like. For example, the security subcomponent may comprise a cryptographic system such as Pretty Good Privacy (PGP).

In some implementations, the operating environment component may include a virtualization subcomponent that facilitates LSP virtualization capabilities. In some embodiments, the virtualization subcomponent may provide support for platform virtualization (e.g., via a virtual machine). Platform virtualization types may include full virtualization, partial virtualization, paravirtualization, and/or the like. In some implementations, platform virtualization may be hardware-assisted (e.g., via support from the processor using technologies such as AMD-V, Intel VT-x, and/or the like). In some embodiments, the virtualization subcomponent may provide support for various other virtualized environments such as via operating-system level virtualization, desktop virtualization, workspace virtualization, mobile virtualization, application virtualization, database virtualization, and/or the like. In some embodiments, the virtualization subcomponent may provide support for various virtualized resources such as via memory virtualization, storage virtualization, data virtualization, network virtualization, and/or the like. For example, the virtualization subcomponent may comprise VMware software suite (e.g., VMware Server, VMware Workstation, VMware Player, VMware ESX, VMware ESXi, VMware ThinApp, VMware Infrastructure), Parallels software suite (e.g., Parallels Server, Parallels Workstation, Parallels Desktop, Parallels Mobile, Parallels Virtuozzo Containers), Oracle software suite (e.g., Oracle VM Server for SPARC, Oracle VM Server for x86, Oracle VM VirtualBox, Oracle Solaris 10, Oracle Solaris 11), Informatica Data Services, Wine, and/or the like.

In some embodiments, components 440 may include a user interface component 440b. The user interface component may facilitate user interaction with the LSP by providing a user interface. In various implementations, the user interface component may include programmatic instructions to obtain input from and/or provide output to the user via physical controls (e.g., physical buttons, switches, knobs, wheels, dials), textual user interface, audio user interface, GUI, voice recognition, gesture recognition, touch and/or multi-touch user interface, messages, APIs, and/or the like. In some implementations, the user interface component may make use of the user interface elements provided by the operating system subcomponent of the operating environment component. For example, the user interface component may make use of the operating system subcomponent's user interface elements via a widget toolkit. In some implementations, the user interface component may make use of information presentation capabilities provided by the information handling subcomponent of the operating environment component. For example, the user interface component may make use of a web browser to provide a user interface via HTML5, Adobe Flash, Microsoft Silverlight, and/or the like.

In some embodiments, components 440 may include any of the components CH 440c, PH 440d described in more detail in preceding figures.

### The Embodiments of the LSP

The entirety of this disclosure (including the written description, figures, claims, abstract, appendices, and/or the like) for LOCALLY SELECTED PLATFORM METHODS, APPARATUSES AND MEDIA shows various embodiments via which the claimed innovations may be practiced. It is to be understood that these embodiments and the features they describe are a representative sample presented to assist in understanding the claimed innovations, and are not exhaustive and/or exclusive. As such, the various embodiments, implementations, examples, and/or the like are deemed non-limiting throughout this disclosure. Furthermore, alternate undescribed embodiments may be available (e.g., equivalent embodiments). Such alternate embodiments have not been discussed in detail to preserve space and/or reduce repetition. That alternate embodiments have not been discussed in detail is not to be considered a disclaimer of such alternate undescribed embodiments, and no inference should be drawn regarding such alternate undescribed embodiments relative to those discussed in detail in this disclosure. It is to be understood that such alternate undescribed embodiments may be utilized without departing from the spirit and/or scope of the disclosure. For example, the organizational, logical, physical, functional, topological, and/or the like structures of various embodiments may differ. In another example, the organizational, logical, physical, functional, topological, and/or the like structures of the LSP coordinator, LSP coordinator elements, LSP data stores, LSP components and their subcomponents, capabilities, applications, and/or the like described in various embodiments throughout this disclosure are not limited to a fixed operating order and/or arrangement, instead, all equivalent operating orders and/or arrangements are contemplated by this disclosure. In yet another example, the LSP coordinator, LSP coordinator elements, LSP data stores, LSP components and their subcomponents, capabilities, applications, and/or the like described in various embodiments throughout this disclosure are not limited to serial execution, instead, any number and/or configuration of threads, processes, instances, services, servers, clients, nodes, and/or the like that execute in parallel, concurrently, simultaneously, synchronously, asynchronously, and/or the like is contemplated by this disclosure. Furthermore, it is to be understood that some of the features described in this disclosure may be mutually contradictory, incompatible, inapplicable, and/or the like, and are not present simultaneously in the same embodiment. Accordingly, the various embodiments, implementations, examples, and/or the like are not to be considered limitations on the disclosure as defined by the claims or limitations on equivalents to the claims.

This disclosure includes innovations not currently claimed. Applicant reserves all rights in such currently unclaimed innovations including the rights to claim such innovations and to file additional provisional applications, nonprovisional applications, continuation applications, continuation-in-part applications, divisional applications, and/or the like. It is to be understood that while some embodiments of the LSP discussed in this disclosure have been directed to a platform for referring consumers and providers, the innovations described in this disclosure may be readily applied to a wide variety of other fields and/or applications.

The following is claimed:

1. A processor-implemented method to obtain a provider recommendation, comprising:
receiving via a processor a description of a job from a consumer;
determining via the processor a referrer qualified to recommend providers to complete the job;
obtaining via the processor a recommendation of a provider to complete the job from the referrer;
confirming via the processor that the recommended provider completed the job; and
awarding via the processor a voucher to the consumer and a voucher to the referrer.

2. The method of claim 1, wherein the description of the job includes a job category and a job subcategory.

3. The method of claim 1, wherein a referrer who utilized a provider in a job category associated with the job is qualified to recommend providers to complete the job.

4. The method of claim 1, wherein a referrer who utilized a provider in a local area associated with the job is qualified to recommend providers to complete the job.

5. The method of claim 1, wherein the referrer cannot recommend providers which the referrer has not used previously.

6. The method of claim 1, wherein the referrer can only recommend one provider for the job.

7. The method of claim 1, further comprising adjusting account balance of an account associated with the provider based on the values of vouchers awarded to the consumer and the referrer.

8. The method of claim 1, wherein the provider pays for all or at least a portion of the value of a voucher awarded to the consumer for registering.

9. The method of claim 1, wherein the provider pays a periodic membership fee.

10. The method of claim 1, further comprising awarding a frequent user voucher to the consumer after a predetermined number of transactions.

11. The method of claim 10, wherein the value of the frequent user voucher is predetermined.

12. The method of claim 10, wherein the value of the frequent user voucher is based on a percentage of the dollar amount of business associated with the transactions.
